(19) United States
(12) Patent Application Publication
(10) Pub. No.: US 2011/0142266 A1
(43) Pub. Date: Jun. 16, 2011

(54) FOLDING-TYPE DIRECTIONAL SPEAKER ARRAY MODULE

(75) Inventors: Hong Yeol LEE, Cheongju (KR); Sung Q Lee, Daejeon (KR); Hye Jin Kim, Daejeon (KR); Kang Ho Park, Daejeon (KR); Jong Dae Kim, Daejeon (KR)

(73) Assignee: Electronics and Telecommunications Research Institute, Daejeon (KR)

(21) Appl. No.: 12/878,394

(22) Filed: Sep. 9, 2010

(30) Foreign Application Priority Data
Dec. 11, 2009 (KR) 10-2009-0123173

(51) Int. Cl. H04R 1/32

(52) U.S. Cl. 381/182

(57) ABSTRACT

In a folding-type directional speaker array module, when sound is output, the directionality of a high frequency band can be obtained through a center speaker module and the directionality of a low frequency band can be obtained through side speaker modules unfolded from both sides of the center speaker module. Accordingly, the speaker array module has excellent directionality in an entire frequency band. Furthermore, the folding-type directional speaker array module has high mobility and portability because the side speaker modules are folded and stored when the folding-type directional speaker array module is not used.

### CROSS-REFERENCE TO RELATED APPLICATION

This application claims the benefit of Korean Patent Application No. 10-2009-0123173, filed Dec. 11, 2009, the disclosure of which is hereby incorporated herein by reference in its entirety.

### BACKGROUND

1. Field of the Invention

The present invention relates to a folding-type directional speaker array module, and more particularly, to a folding-type directional speaker array module having high mobility and portability as well as excellent directionality even in a low frequency band.

2. Discussion of Related Art

In conventional portable communication terminals, speakers are used for communications such as simple voice communication. However, in recent portable communication terminals, speakers are utilized to reproduce sound for a variety of high-quality contents of video communications, digital multimedia broadcasting (DMB), various games and movies, and so on.

However, when sound is output through speakers, unspecified individuals are subjected to auditory stimuli due to natural radiation of the sound. For this reason, headphones and earphones are generally used to minimize the auditory stimuli, but these jar on the user's ears. Accordingly, there is a high need for directional speakers capable of minimizing the auditory stimuli in the field of portable communication terminals.

The directional speaker can output sound only in a desired direction to form a personal sound space. The directional speakers include an ultrasonic-type directional speaker, a dome-type directional speaker, and an array-type directional speaker.

The ultrasonic-type speaker has excellent directionality but consumes a great amount of energy to generate a high ultrasonic wave and provides low sound quality, and the dome-type speaker is bulky and provides poor directionality because of its wide dome-shaped reflector. For this reason, the array-type directional speaker capable of providing excellent sound quality and high directionality even in a low frequency band has been widely used.

FIG. 1 illustrates a conventional array-type directional speaker module 100.

Referring to FIG. 1, the conventional array-type directional speaker module 100 outputs sound signals having different sound pressures and phases through aligned speakers 110, such that a listener can listen to sound only in a desired area.

An interval between the speakers in the array-type directional speaker module 100 must increase in proportion to a wavelength of a low frequency signal in order to obtain directionality of a low frequency band.

However, since a total size of the speaker module increases with the interval between the speakers, the mobility and portability of the speaker module 100 is degraded.

### SUMMARY OF THE INVENTION

The present invention is directed to a folding-type directional speaker array module having high mobility and portability as well as excellent directionality even in a low frequency band.

According to one aspect of the present invention, a folding-type directional speaker array module includes: a center speaker module for obtaining directivity of a high frequency band; and side speaker modules respectively disposed at both sides of the center speaker module for obtaining directionality of a low frequency band, wherein at least one of the center speaker module and the side speaker modules is made in a folding-type structure for high mobility and portability.

The center speaker module may include a plurality of speaker units disposed at an interval for obtaining the directionality of the high frequency band, and each side speaker module may include a plurality of speaker units disposed at an interval for obtaining the directionality of the low frequency band.

The speaker array module may further include a hinge in a connection portion between the center speaker module and each side speaker module. When the speaker array module is not used, the side speaker modules may be folded from both sides of the center speaker module by the hinges.

When sound is output, the directionality of the high frequency band may be obtained through the center speaker module and the directionality of the low frequency band may be obtained through the side speaker modules unfolded from the both sides of the center speaker module.

### BRIEF DESCRIPTION OF THE DRAWINGS

FIG. 1 illustrates a conventional array-type directional speaker module.

FIGS. 2A and 2B illustrate a folding-type directional speaker array module according to an exemplary embodiment of the present invention.

FIG. 3 illustrates a folding-type directional speaker array module according to another exemplary embodiment of the present invention.

FIGS. 4A to 4E illustrate sound lobes according to a frequency in the folding-type directional speaker array module in FIG. 3.

### DETAILED DESCRIPTION OF EXEMPLARY EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout the specification.

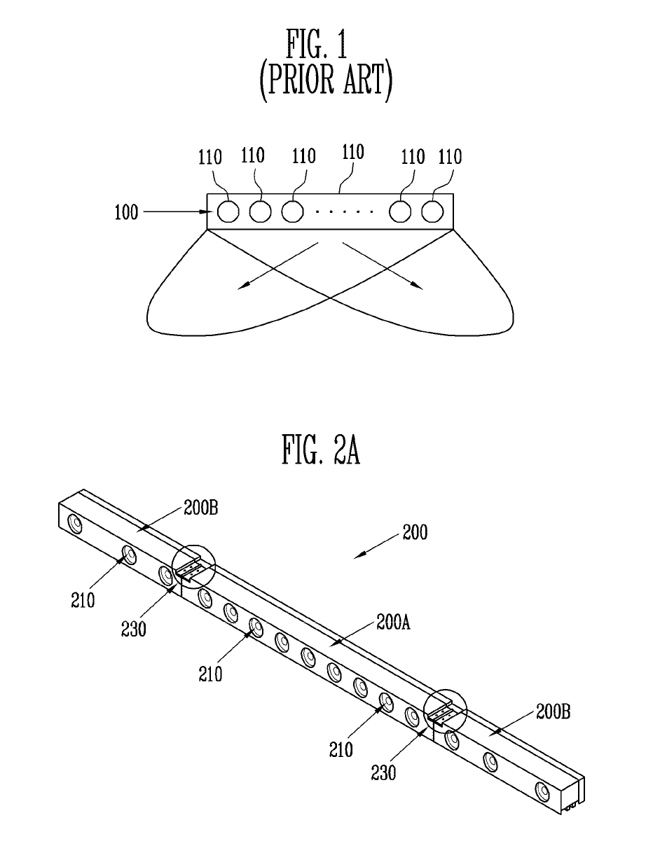

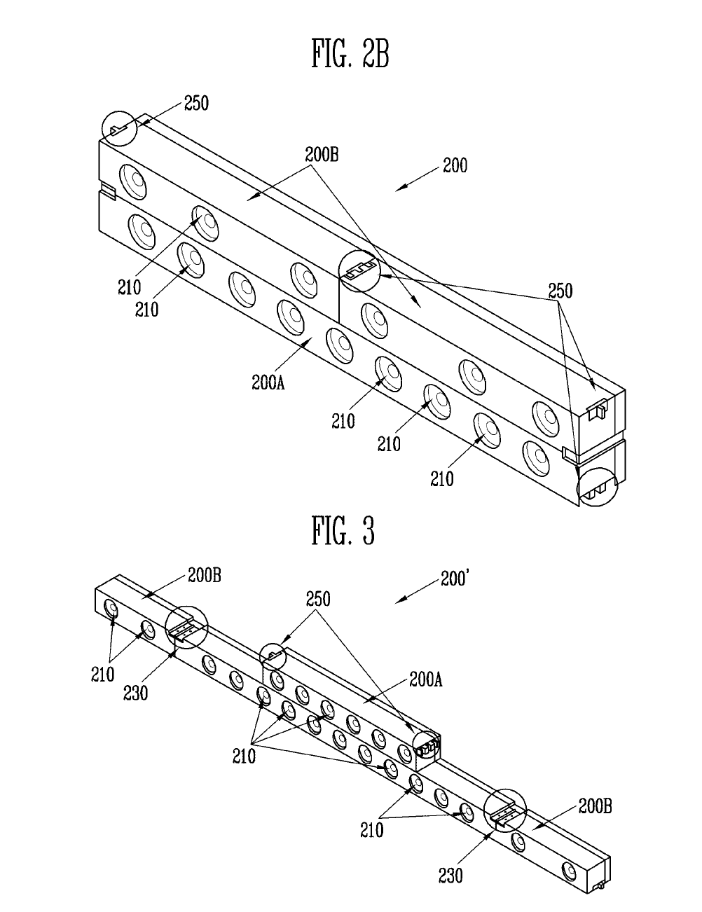

FIGS. 2A and 2B illustrate a folding-type directional speaker array module 200 according to an exemplary embodiment of the present invention. FIG. 2A illustrates the folding-type directional speaker array module 200 when unfolded in a line, and FIG. 2B illustrates the folding-type directional speaker array module 200 when folded for mobility and portability.

Referring to FIG. 2A, the folding-type directional speaker array module 200 according to an exemplary embodiment of the present invention includes a center speaker module 200A for obtaining directivity of a high frequency band and side speaker modules 200B respectively disposed at both sides of the center speaker module 200A for obtaining directionality of a low frequency band.

The center speaker module 200A includes a plurality of speaker units 210 disposed at an interval for obtaining the directionality of the high frequency band, and each of the side speaker modules 200B includes a plurality of speaker units 210 disposed at an interval for obtaining the directionality of the low frequency band.

Here, examples of the speaker unit 210 may include a voice coil-type speaker, a piezoelectric-type speaker, and an ultrasonic wave transducer.

Hinges 230 are provided in connection portions between the center speaker module 200A and the side speaker module 200B.

Referring to FIG. 2B, the side speaker modules 200B may be folded from the both sides of the center speaker module 200A by the hinges 230 and received on or beneath the center speaker module 200A.

Stoppers 250 such as ball catches for maintaining a folded state of the side speaker modules 200B are provided at ends of the side speaker modules 200B that are folded and at the other ends of the side speaker modules 200B that meet each other.

When sound is output, the side speaker modules 200B are unfolded from the both sides of the center speaker module 200A as shown in FIG. 2A, such that the directionality of the high frequency band and the directionality of the low frequency band can be obtained through the center speaker module 200A and the side speaker modules 200B, respectively. As a result, excellent directionality is achieved in the entire frequency band.

When the speaker array module is not used, the side speaker modules 200B are folded from the both sides of the center speaker module 200A by the hinges 230 and received on or beneath the center speaker module 200A, as shown in FIG. 2B, thereby achieving high mobility and portability.

Although the side speaker modules 200B having a relatively greater size are made in a folding-type structure in the present exemplary embodiment as described above, the center speaker module 200A may be made in the folding-type structure or both of the side speaker modules 200B and the center speaker module 200A may be made in the folding-type structure according to circumferences.

Although the center speaker module 200A and the side speaker modules 200B are connected by the hinge structure as described above, they may be connected by a dovetail structure or a tongue and groove structure.

FIG. 3 illustrates a folding-type directional speaker array module 200′ according to another exemplary embodiment of the present invention.

Referring to FIG. 3, the folding-type directional speaker array module 200′ according to another exemplary embodiment of the present invention has a structure in which a center speaker module 200A for obtaining directivity of a high frequency band is formed in two lines for the efficiency of a space when the center speaker module 200A is too large to be formed in one line.

Even in this case, since the side speaker modules 200B are folded by the hinges 230, the folding-type directional speaker array module 200′ has a small size, thereby achieving high mobility and portability.

In particular, the folding-type directional speaker array modules 200 and 200′ according to the present invention have high mobility and portability as well as excellent directionality in the low frequency band, as will be described below in greater detail.

In general, in order to obtain directionality of a specific frequency band, an interval d between the speaker units 210 must satisfy the following Equation 1:

d=c/f Equation 1

where c denotes the speed of sound and f denotes a frequency band the directionality of which is to be obtained.

According to Equation 1, an interval of 34 cm between the speaker units is required to obtain directionality of a sound frequency band of 1 kHz. When a directional speaker module is embodied in a symmetric structure with respect to a center, the directional speaker module must be made in a size of 68 cm or greater.

The directional speaker module must have size of about 2.3 m to obtain directionality of 300 Hz, which is a low frequency in a sound frequency band, and a size of 1.4 m to obtain directionality of 500 Hz.

However, the directional speaker module having such a great size has low mobility and portability.

Thus, since the side speaker modules 200B for obtaining the directionality of the low frequency band are made in a folding-type structure, the speaker array module of the present invention has ½ a size of a conventional speaker array module, thereby achieving high mobility and portability.

For example, in the present invention, a size of 1.2 m or less is required to obtain the directionality of 300 Hz and a size of 0.7 m or less is required to obtain the directionality of 500 Hz

If the entire directional speaker array module is divided into three pieces for a hinge structure, the entire directional speaker array module can be embodied in ⅓ of the size.

In addition to the high mobility and portability, the folding-type directional speaker array modules 200 and 200′ according to the present invention allow sound to be heard only inside a personal sound space by properly controlling sound pressure and phase of a sound signal output from each speaker unit 210.

Further, the folding-type directional speaker array modules 200 and 200′ according to the present invention can obtain the directionality of high frequency band from the speaker units 210 in the center speaker module 200A and the directionality of the low frequency band from the speaker units 210 in the side speaker module 200B. Thus, the folding-type directional speaker array modules 200 and 200′ have excellent directionality in the entire frequency band.

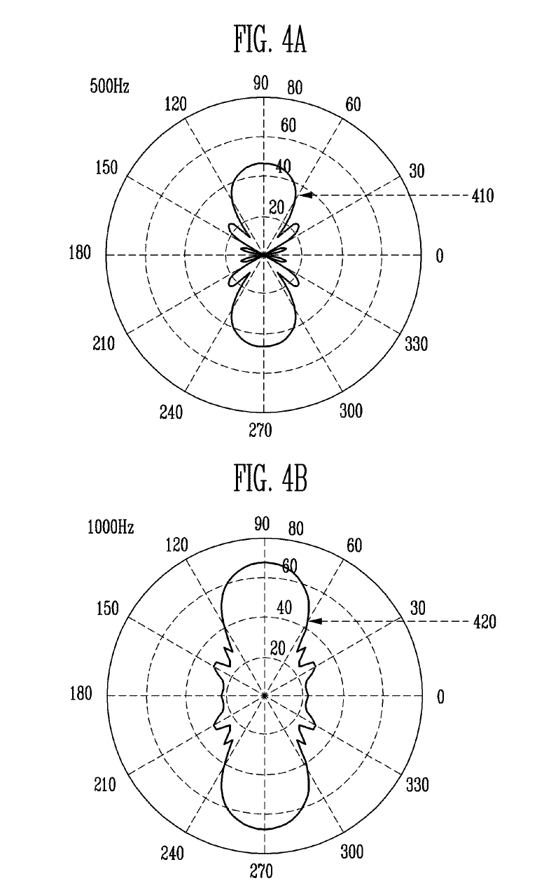

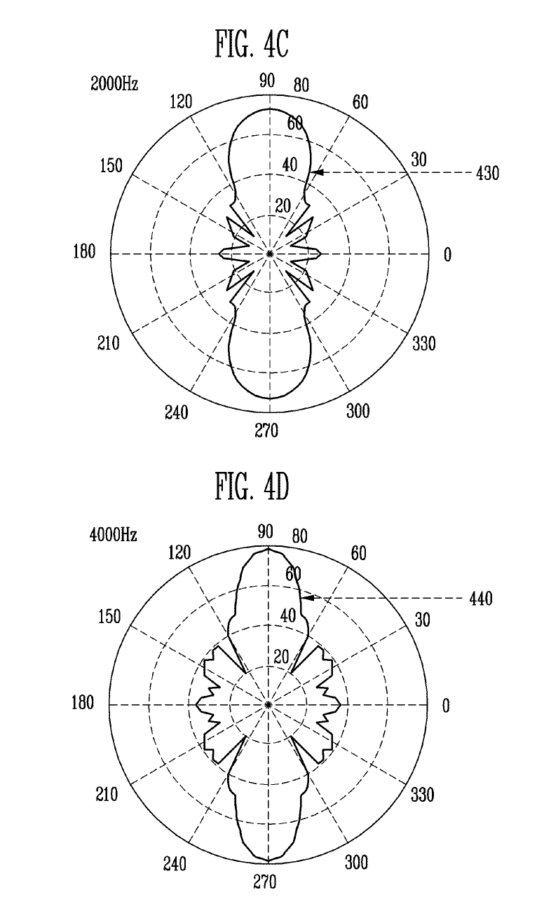

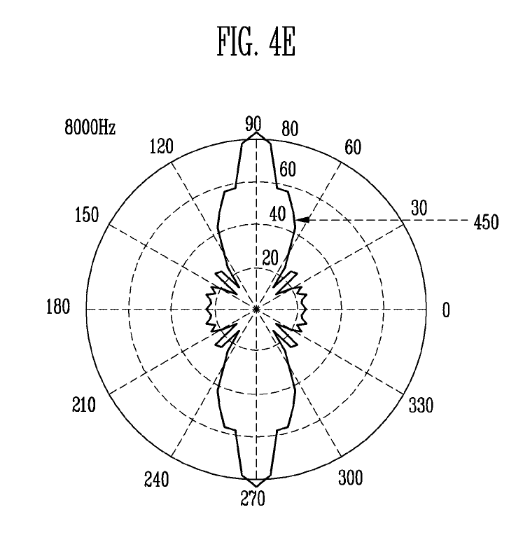

FIGS. 4A to 4E illustrate sound lobes according to a frequency in the folding-type directional speaker array module 200′ shown in FIG. 3.

First, it can be seen that a directional lobe 410 in a low frequency band of 500 Hz has powerful directionality at a small angle substantially without a side lobe, as shown in FIG. 4A. It can also be seen that since a difference between sound pressure at a central position (90° position) 1 m away from a sound source and sound pressure at left and right 30° positions is 15 dB or more, a low frequency sound signal does not spread over a specific distance.

It can be seen that directional lobes 420, 430, 440, and 450 in a high frequency band of 1000 Hz or more also have powerful directionality at a small angle substantially without a side lobe, as shown in FIGS. 4B to 4E. It can also be seen that since a difference between sound pressure at a central position (90° position) 1 m away from the sound source and sound pressure at left and right 25° positions is 25 dB or greater, a high frequency sound signal does not spread over a specific distance.

Accordingly, a listener can accurately listen to a sound signal including a low frequency sound signal and a high frequency sound signal in a personal sound space.

As described above, the folding-type directional speaker array modules 200 and 200′ according to the present invention have excellent directionality in the entire frequency band sound because the directionality of the high frequency band can be obtained through the center speaker module 200A and the directionality of the low frequency band can be obtained through the side speaker modules 200B unfolded from the both sides of the center speaker module 200A when sound is output.

Furthermore, the folding-type directional speaker array modules 200 and 200′ according to the present invention have high mobility and portability because the side speaker modules 200B having a greater size can be folded and received from the both sides of the center speaker module 200A.

In a folding-type directional speaker array module according to the present invention, when sound is output, the directionality of the high frequency band can be obtained through the center speaker module and the directionality of the low frequency band can be obtained through the side speaker modules unfolded from both sides of the center speaker module. Accordingly, the speaker array module has excellent directionality in an entire frequency band.

Furthermore, the folding-type directional speaker array module according to the present invention has high mobility and portability because the side speaker modules are folded and stored when folding-type directional speaker array module is not used.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A folding-type directional speaker array module, comprising:
a center speaker module for obtaining directivity of a high frequency band; and
side speaker modules respectively disposed at both sides of the center speaker module for obtaining directionality of a low frequency band,
wherein at least one of the center speaker module and the side speaker modules is made in a folding-type structure for high mobility and portability.

2. The speaker array module of claim 1, wherein the center speaker module comprises a plurality of speaker units disposed at an interval for obtaining the directionality of the high frequency band, and each side speaker module comprises a plurality of speaker units disposed at an interval for obtaining the directionality of the low frequency band.

3. The speaker array module of claim 2, wherein the interval d between the plurality of speaker units is calculated by:
d=c/f
where c denotes the speed of sound and f denotes a frequency band the directionality of which is to be obtained.

4. The speaker array module of claim 1, further comprising a hinge in a connection portion between the center speaker module and each side speaker module.

5. The speaker array module of claim 4, wherein when the speaker array module is not used, the side speaker modules are folded from both sides of the center speaker module by the hinges.

6. The speaker array module of claim 5, further comprising stoppers for maintaining a folded state of the side speaker modules.

7. The speaker array module of claim 5, wherein when sound is output, the directionality of the high frequency band is obtained through the center speaker module and the directionality of the low frequency band is obtained through the side speaker modules unfolded from the both sides of the center speaker module.

8. The speaker array module of claim 2, wherein each of the center speaker module and the side speaker modules comprises a plurality of speaker units arranged in at least one line.

9. The speaker array module of claim 8, wherein the speaker units arranged in the center speaker module and the side speaker modules output a sound signal having a different sound pressure and a different phase.
